(19) United States
(12) Patent Application Publication
(10) Pub. No.: US 2007/0132120 A1
(43) Pub. Date: Jun. 14, 2007

(54) Preferential release of an ophthalmic lens using a super-cooled fluid

(75) Inventors: Sanjay Rastogi, Rochester, NY (US); Gary Friends, Ontario, NY (US); Mahendra Nandu, Pittsford, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/598,577

(22) Filed: Nov. 13, 2006

Related U.S. Application Data
(60) Provisional application No. 60/748,378, filed on Dec. 8, 2005.

(51) Int. Cl. B29D 11/00

(52) U.S. Cl. 264/1.1; 264/334

(57) ABSTRACT

The present invention, in one embodiment, is a process for extracting pre-polymer from a polymer lens. The process of one embodiment comprises the step of contacting the ophthalmic lens with a super-cooled solvent for a period of time sufficient to extract pre-polymer from the polymer lens.

### CROSS REFERENCE

This application claims the benefit of Provisional Patent Application No. 60/748,378 filed Dec. 8, 2005 and is incorporated herein by reference.

### BACKGROUND OF THE INVENTION

1. Field of the Invention

The present invention relates to the release of ophthalmic lenses from ophthalmic lens molds using a super-cooled fluid.

2. Discussion of Related Art

Most ophthalmic lenses are molded in disposable polyethylene or polypropylene molds. Specifically, an ophthalmic lens is made of two mold halves. The anterior mold half defines the convex surface of the ophthalmic lens. The posterior mold half defines the concave surface of the ophthalmic lens. During the molding process, a predetermined amount of a pre-polymer mixture is placed in the anterior mold half. Optionally, a reservoir in the mold is formed to receive excess monomer when the mold halves are placed together.

The posterior mold half is pressed against the anterior mold half forming the desired shape of the ophthalmic lens. After the mold halves are placed together, a curing step occurs. In one embodiment, the curing step occurs by application of ultraviolet light that catalyzes a polymerization reaction. Molds of an amorphous material are preferred because the size of the mold, and hence molded article, does not change with differences in temperature. However, amorphous lenses are brittle. It is particularly difficult to deform an amorphous mold to remove a highly flexible silicone hydrogel lens. Wet release of the ophthalmic lens hydrates the ophthalmic lens. The swelling of the ophthalmic lens overcomes the interactions that cause the ophthalmic lens to adhere to the mold.

Separating an ophthalmic lens from two mold halves requires a first step of decapping and a second step of removal from the ophthalmic lens. Decapping occurs by deforming one of the two lens halves, typically the anterior mold half, to selectively separate the mold half from the ophthalmic lens. Two problems arise with decapping that is unconsidered by the prior art.

First, the preferred amorphous mold or mold halves are more likely to shatter when a deforming force is used to selectively separate the ophthalmic lens from the mold or mold halves. Shattering of the mold or mold half is likely to damage the ophthalmic lens. Most amorphous mold or mold halves are not used for ophthalmic lens processes that use a dry release method that require deformation of the mold to remove the ophthalmic lens from mold. Instead, the ophthalmic lenses are released from the mold or mold halves by hydrating the ophthalmic lens. Hydration allows the use of amorphous molds However, once an ophthalmic lens is hydrated, it is difficult to perform additional processing steps such as de-edging, surface treatment, etc. due to the presence of water in the hydrogel matrix and the dramatic decrease in the ophthalmic lens modulus.

Second, the silicone hydrogel ophthalmic lenses are highly deformable (even before hydration) and obtaining preferential release (i.e. consistent release of one mold half from the ophthalmic lens versus the other mold half) with any dry release method is difficult to obtain.

The casting of polymers in molds and the release of the cast materials from the molds is well established. It is also well established that increasing the modulus of the cast material facilitates the removal of the cast material from the mold. For example, it is known that cooling of the mold and/or the cast material not only increases the modulus of the material but also causes the cast material to shrink and separate from the mold, thereby facilitating removal of the cast material from the mold. See U.S. Pat. No. 5,259,998, incorporated by reference herein.

Cryogenic nitrogen, for example, has been used to cause lenses to shrink and separate from a mold. Similarly, it is known that materials cast in the presence of a solvent can be removed from molds by evaporating at least a portion of the solvent thereby causing the modulus of the cast material to increase and the material to shrink and separate from the mold. See Japan Publication No. 01152015, incorporated by reference herein.

European Patent 1,224,073 teaches a process that mechanically decaps the ophthalmic lens. Thereafter, a cryogenic fluid is used to release a contact lens from one mold half after decapping. The process then hydrates the contact lens after the step of decapping before any additional processing steps are performed.

U.S. Pat. No. 3,750,272 teaches a process for machine contact lenses of flexible material. A jet of liquid nitrogen or liquid air is sprayed onto the ophthalmic lens during rotation of the ophthalmic lens, which continues until the diameter of the ophthalmic lens is reduced. Then, the peripheral edge is machined.

Thus, there still exists a need for an improved process for releasing an ophthalmic lens, preferably a silicone hydrogel ophthalmic lens, from a mold, preferably an amorphous mold, without the aid of a wet release process.

### SUMMARY OF THE INVENTION

The present invention is a process for manufacturing an ophthalmic lens, including but not limited to a contact lens or an intraocular lens, comprising forming an ophthalmic lens from pre-polymer in a mold having an anterior half and a posterior half. The anterior half and the posterior half are arbitrarily designated as one half or the other half. One half of the ophthalmic lens mold is contacted with a super-cooled fluid to preferentially release the ophthalmic lens from the one half. A temperature differential is created between the other half of the ophthalmic lens mold with a super-cooled fluid to release the ophthalmic lens from the other half. The process of the present invention makes engineering the formulation more forgiving. In other words, it allows efficient manufacturing of a wider variety of materials and effectively release.

In one embodiment, the one half of the ophthalmic lens mold is the posterior half. In another embodiment, the other half of the ophthalmic lens mold is the anterior half of the ophthalmic lens mold. In an embodiment, the non-critical surface of the mold is contacted with the super-critical fluid. The non-critical surface of the mold is the portion of the mold that does not contact the lens material during the molding process.

In an embodiment, the step of forming produces a reservoir ring formed from excess pre-polymer, the process further comprises the step of creating a temperature differential between the reservoir ring and the ophthalmic lens to facilitate separation of the reservoir ring from the ophthalmic lens.

Typically, the mold is made of an amorphous polymer. Amorphous polymers of one embodiment are selected from the group consisting of polyethylene terephthalate, polystyrene, polycarbonate, copolymers of ethylene and a cyclic olefin and mixtures thereof.

In an embodiment, the ophthalmic lens is made from a silicone containing pre-polymer. Generally, the silicone containing pre-polymers include but are not limited to hydrophilic pre-polymer. In another embodiment, at least one pre-polymer is selected from the group consisting of amide monomers such as N,N-dimethylacrylamide and N,N-dimethylmethacrylamide; cyclic lactam monomers such as N-vinyl-2-pyrrolidone; (meth)acrylated alcohol monomers, such as 2-hydroxyethylmethacrylte and 2-hydroxyethylacrylate; (meth)acrylated poly(alkene glycol) monomers, such as poly(diethylene glycol) monomers of varying chain length containing monomethacrylate or dimethacrylate; hydrophilic vinyl carbonate monomers; hydrophilic vinyl carbamate monomers; and hydrophilic oxazolone monomers.

In one embodiment, the ophthalmic lens has a modulus that is a minimum of about 20 g/mm², about 30 g/mm², about 40 g/mm², about50 g/mm², about 75 g/mm², about 100 g/mm² and a maximum of about 200 g/mm², about 175 g/mm², about 150 g/mm², about 125 g/mm², about 100 g/mm², about 80 g/mm², about 75 g/mm² or about 70 g/mm² after the contact lens is hydrated.

In one embodiment, the step of contacting occurs for a minimum of about 0.1 seconds to a maximum of about 20 seconds. Preferably, the step of contacting occurs by spraying the super-cooled fluid over the exterior of the one half of the ophthalmic lens. The step of contacting, optionally, occurs by dispensing a volume of super-cooled fluid on the exterior of the one half of the ophthalmic lens mold.

In another embodiment, the step of creating a temperature differential occurs by contacting a super-cooled fluid against the other half of the ophthalmic lens mold. The step of creating a temperature differential occurs, optionally, by contacting a super-cooled fluid against the other half of the mold for a minimum of about 0.1 seconds to a maximum of about 20 seconds.

Optionally, the step of creating a temperature differential contacts the super-cooled fluid against the ophthalmic lens. Alternatively and optionally, the step of creating a temperature differential contacts the super-cooled fluid against the ophthalmic lens for a minimum of about 0.1 seconds to a maximum of about 20 seconds. In one embodiment, the step of creating a temperature differential comprises spraying the super-cooled fluid over the exterior of the other half of the ophthalmic lens mold.

The step of creating a temperature differential, in one embodiment, comprises spraying the super-cooled fluid over the ophthalmic lens.

The step of creating a temperature differential, in another embodiment, comprises dispensing a volume of super-cooled fluid on the exterior of the other half.

The step of creating a temperature differential comprises dispensing a volume of super-cooled fluid on the exterior of the other half of the ophthalmic lens in one embodiment.

The super-cooled fluid, typically, is at a temperature below about minus 40° C.

The super-cooled fluid is selected from the group consisting essentially of nitrogen, argon, helium, air and carbon dioxide. The super-cooled fluid is preferentially a cryogenic fluid.

In one embodiment, there is a process for removing an ophthalmic lens from a mold, the process comprising the step of providing an ophthalmic lens in a mold comprising a first mold half and a second mold half. A first temperature differential between the first mold half and the ophthalmic lens is created to separate the first mold half from the ophthalmic lens. A second temperature differential is created between the second mold half and the ophthalmic lens to separate the second mold half from the ophthalmic lens.

In one embodiment, the ophthalmic lens has a reservoir ring formed from excess pre-polymer, further comprising the step of creating a temperature differential between the reservoir ring and the ophthalmic lens to facilitate separation of the reservoir ring from the ophthalmic lens.

In another embodiment, the mold is made of an amorphous polymers. The ophthalmic lens, optionally, is made from a silicone containing pre-polymer. The pre-polymer is a hydrophilic pre-polymer.

In still another embodiment, the step of creating a first temperature differential occurs by spraying the super-cooled fluid over the exterior of the first half.

Optionally and alternatively, the step of creating a first temperature differential occurs by dispensing a volume of super-cooled fluid on the exterior of the first half.

In yet another embodiment, the step of creating a second temperature differential occurs by contacting a super-cooled fluid against the second half of the mold.

In an embodiment, the step of creating a second temperature differential occurs by contacting a super-cooled fluid against the second half of the mold for a minimum of about 0.1 seconds to a maximum of about 20 seconds.

The step of creating a second temperature differential contacts the super-cooled fluid against the ophthalmic lens, in one embodiment. Preferably, for a time period that is a minimum of about 0.1 seconds to a maximum of about 20 seconds. Optionally, the step of creating a second temperature differential comprises spraying the super-cooled fluid over the exterior of the second half. In another-embodiment, the step of creating a second temperature differential comprises spraying the super-cooled fluid over the ophthalmic lens.

In still another embodiment, the step of creating a temperature differential comprises dispensing a volume of super-cooled fluid on the exterior of the second half. In one embodiment, the step of creating a temperature differential comprises dispensing a volume of super-cooled fluid on the surface of the ophthalmic lens.

In one embodiment, there is a process for separating a silicone hydrogel ophthalmic lens from at least one mold half including the anterior half and the posterior half of an ophthalmic lens. The process comprises the step of contacting either the ophthalmic lens or the one half with a maximum of about 1000 μl of a super-cooled fluid to create a temperature differential between the ophthalmic lens and the one half.

In one embodiment, a maximum of about 750 μl, about 600 μl or about 500 μl of super-cooled fluid is contacted with either the one half or the ophthalmic lens.

In another embodiment, there is a process for manufacturing an ophthalmic lens. The process comprises a step of forming an ophthalmic lens in a mold from a pre-polymer. The ophthalmic lens is released from the mold with a super-cooled fluid. An additional dry processing step is performed following release from the mold before hydration of the ophthalmic lens.

Typically, the additional dry processing step is selected from the group comprising inspection of the ophthalmic lens in a dry state; edging the ophthalmic lens; depositing a plasma coating on the ophthalmic lens; and extracting monomers or impurities from the ophthalmic lens with a non-aqueous fluid.

In one embodiment, the mold is an amorphous polymer and the polymer is a silicone hydrogel polymer.

### DETAILED DESCRIPTION OF THE INVENTION

One method in practice for making ophthalmic lenses including ophthalmic lenses and intraocular lenses is cast molding. Cast molding of ophthalmic lenses involves depositing a curable mixture of polymerizable lens materials, such as pre-polymers, in a mold cavity formed by two assembled mold sections, curing the mixture, disassembling the mold sections and removing the molded lens. As used herein, the term “pre-polymer” and like terms denote compounds that are inserted into an ophthalmic lens mold to be polymerized by free radical polymerization, the term includes monomers and macromonomers and related terms.

Other post-molding processing steps may also be employed. Representative cast molding methods are disclosed in U.S. Pat. No. 5,271,875 (Appleton et al.); U.S. Pat. No. 4,197,266 (Clark et al.); U.S. Pat. No. 4,208,364 (Shepherd); U.S. Pat. No. 4,865,779 (Ihn et al.); U.S. Pat. No. 4,955,580 (Seden et al.); U.S. Pat. No. 5,466,147 (Appleton et al.); and U.S. Pat. No. 5,143,660 (Hamilton et al.).

Cast molding occurs between a pair of mold sections. Typically, one mold section, referred to as the anterior mold section forms the anterior, convex, optical surface of the ophthalmic lens. The other mold section, referred to as the posterior mold section, forms the posterior, concave, optical surface of the ophthalmic lens. The anterior and posterior mold sections are generally complimentary in configuration.

Typically, a predetermined amount of a liquid mixture including uncured pre-polymer and solvent is placed in the anterior mold section. The posterior mold section is placed over the anterior mold section and takes the shape of the ophthalmic lens. If the desired lens is aspheric, the posterior mold section must be axially positioned relative to anterior mold halve to create proper aspheric shape. The predetermined amount is slightly greater than the volume of the ophthalmic lens mold. A small portion of the pre-polymer mixture overflows in a radially spaced apart overflow reservoir that surrounds the circumference of the ophthalmic lens. Then, the ophthalmic lens is cured by a curing technique such as exposure to ultraviolet radiation.

Once the ophthalmic lens is formed, the mold sections are separated and the molded lens is removed in a multi-step process. The anterior and posterior mold sections are usually used only once for casting an ophthalmic lens prior to being discarded due to the significant degradation of the optical surfaces of the mold sections that often occurs during a single casting operation.

Since, the mold for use in making the ophthalmic lens is generally a single use item, the use of inexpensive materials for the anterior and posterior mold halves is advantageous. Accordingly, a thermoplastic resin or a thermosetting resin such as, for example, polypropylene, polyethylene, polyethylene terephthalate, polystyrene, polycarbonate, polyvinyl chloride, polyamide, polyacetal or fluorocarbon resin is acceptable for use. Preferably, the mold or mold half polymer is amorphous. By amorphous it is meant materials that are thermoset. Examples of amorphous materials include but are not limited to polyethylene terephthalate, polystyrene, polycarbonate or copolymers of ethylene and a cyclic olefin. See W09947344.

Mold/Mold Half Formation

Formation of the mold sections used in casting occurs through a separate molding process prior to cast molding. In this regard, the mold sections are first formed by injection molding a resin in the cavity of an injection molding apparatus. Molds are formed of an anterior mold half and a posterior mold half. The anterior mold half forms the concave surface of the ophthalmic lens. The posterior mold half forms the convex surface of the ophthalmic lens. As used herein, one mold half refers arbitrarily to either the anterior mold half or the posterior mold half. The other mold half refers to its corresponding pair. Thus, when one mold half refers to an anterior mold half, the other mold half refers to the posterior mold half. Likewise the phrase, “first mold half” and “second mold half” can be used interchangeably with one mold half and the other mold half and no reference is intended to sequence, priority or any criteria of order.

Each mold section, whether it is a posterior mold section or an anterior mold section, includes an optical surface (posterior optical surface on a posterior mold section and anterior optical surface on an anterior mold section) that forms a surface of the ophthalmic lens, as well as a non-optical surface. When injection molding the mold section, the injection molding apparatus typically includes an optical tool assembly for forming the optical surface of the mold section and a non-optical tool assembly for forming the non-optical surface of the mold section. When the ophthalmic lens to be formed includes an asymmetric surface, the mold section optical surface used to form the asymmetric lens surface and the optical tool assembly used to form the mold section optical surface each include corresponding asymmetric surfaces.

Materials

Hydrogels represent one class of materials used for many device applications, including ophthalmic lenses that are made by the molding process. Hydrogels comprise a hydrated, cross-linked polymeric systems containing water in an equilibrium state. Accordingly, hydrogels are copolymers prepared from hydrophilic pre-polymers. In the case of silicone hydrogels, the hydrogel copolymers are generally prepared by polymerizing a mixture containing at least one device-forming silicone-containing pre-polymer and at least one device-forming hydrophilic pre-polymer. Either the silicone-containing pre-polymer or the hydrophilic pre-polymer may function as a crosslinking agent (a crosslinking agent being defined as a pre-polymer having multiple polymerizable functionalities), or alternately, a separate crosslinking agent may be employed in the initial pre-polymer mixture from which the hydrogel copolymer is formed. Silicone hydrogels typically have a water-content ranging from about 10 wt.% to about 80 wt.%.

Examples of useful device-forming hydrophilic pre-polymers include: amides such as N,N-dimethylacrylamide and N,N-dimethylmethacrylamide; cyclic lactams such as N-vinyl-2-pyrrolidone; (meth)acrylated alcohols, such as 2-hydroxyethylmethacrylte and 2-hydroxyethylacrylate; and (meth)acrylated poly(alkene glycols), such as poly(diethylene glycols) of varying chain length containing monomethacrylate or dimethacrylate end caps. Still further examples are the hydrophilic vinyl carbonate or vinyl carbamate pre-polymers disclosed in U.S. Pat No. 5,070,215, and the hydrophilic oxazolone pre-polymers disclosed in U.S. Pat. No. 4,910,277, the disclosures of which are incorporated herein by reference. Other suitable hydrophilic pre-polymers will be apparent to one skilled in the art.

As mentioned, one preferred class hydrogel ophthalmic lens materials is silicone hydrogels. In this case, the initial lens-forming monomer mixture further comprises a silicone-containing monomer.

Applicable silicone-containing monomeric materials for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Examples of applicable silicon-containing monomers include bulky polysiloxanylalkyl (meth)acrylic monomers. An example of bulky polysiloxanylalkyl (meth)acrylic monomers are represented by the following Formula I: 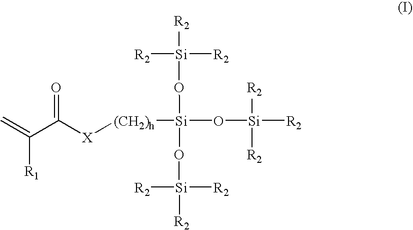
wherein:

X denotes —O— or —NR—;

each R₁ independently denotes hydrogen or methyl;

each R₂ independently denotes a lower alkyl radical, phenyl radical or a group represented by

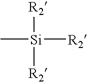

wherein each R′_{2′} independently denotes a lower alkyl or phenyl radical; and h is 1 to 10. One preferred bulky monomer is methacryloxypropyl tris(trimethyl-siloxy)silane or tris(trimethylsiloxy)silylpropyl methacrylate, sometimes referred to as TRIS.

Another class of representative silicon-containing monomers includes silicone-containing vinyl carbonate or vinyl carbamate monomers such as: 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(tri-methylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; and trimethylsilylmethyl vinyl carbonate.

An example of silicon-containing vinyl carbonate or vinyl carbamate monomers are represented by Formula II: 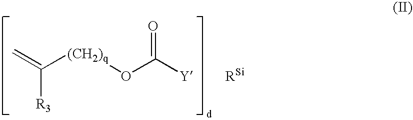
wherein:

Y′ denotes —O—, —S— or —NH—;

R^{si} denotes a silicone-containing organic radical;

R₃ denotes hydrogen or methyl;

d is 1, 2, 3 or 4; and q is 0 or 1.

Suitable silicone-containing organic radicals R^{Si} include the following:
−(CH₂)_{n′}Si[(CH₂)_{m′}CH₃]_{3 ;}
−(CH₂)_{n′}Si[OSi(CH₂)_{m′}CH₃]_{3 ;}

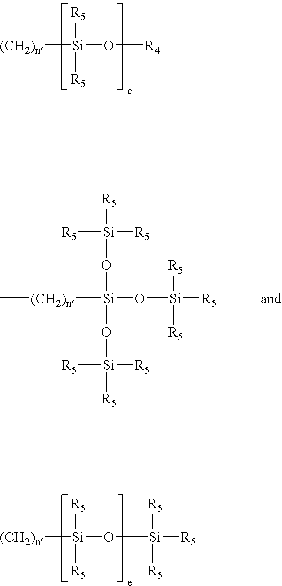

wherein:

R₄ denotes 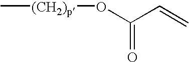
wherein p′ is 1 to 6;

R₅ denotes an alkyl radical or a fluoroalkyl radical having 1 to 6 carbon atoms;

e is 1 to 200; n′ is 1, 2, 3 or 4; and m′ is 0, 1, 2, 3, 4 or 5.

An example of a particular species within Formula II is represented by Formula III:

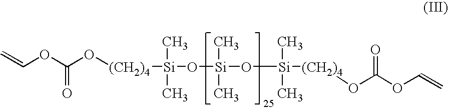

Another class of silicon-containing monomers includes polyurethane-polysiloxane macromonomers (also sometimes referred to as prepolymers), which may have hard-soft-hard blocks like traditional urethane elastomers. Examples of silicone urethane monomers are represented by Formulae IV and V:
E(*D*A*D*G)ₐ*D*A*D*E′; or (IV)
E(*D*G*D*A)ₐ*D*G*D*E′; (V)
wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

a is at least 1;

A denotes a divalent polymeric radical of Formula VI: 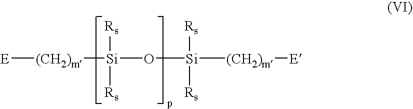
wherein:
each Rₛ independently denotes an alkyl or fluoro-substituted alkyl group having 1 to 10 carbon atoms which may contain ether linkages between carbon atoms;
m′ is at least 1; and
p is a number which provides a moiety weight of 400 to 10,000;
each of E and E′ independently denotes a polymerizable unsaturated organic radical represented by Formula VII: 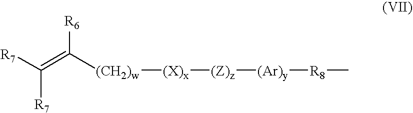
wherein:

R₆ is hydrogen or methyl;

R₇ is hydrogen, an alkyl radical having 1 to 6 carbon atoms, or a —CO—Y—R₉ radical wherein Y is —O—, —S— or —NH—;

R₈ is a divalent alkylene radical having 1 to 10 carbon atoms;

R₉ is a alkyl radical having 1 to 12 carbon atoms;

X denotes —CO— or —OCO—;

Z denotes —O— or —NH—;

Ar denotes an aromatic radical having 6 to 30 carbon atoms;

w is 0 to 6; x is 0 or 1; y is 0 or 1; and z is 0 or 1.

A more specific example of a silicone-containing urethane monomer is represented by Formula (VIII):

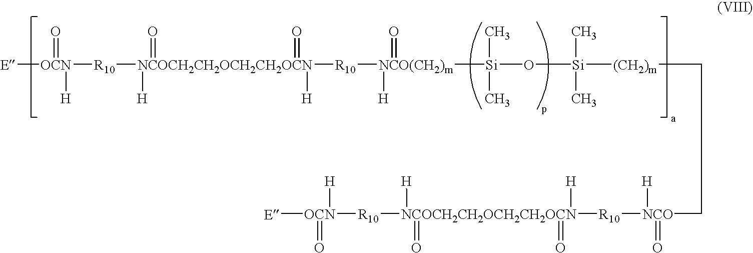

wherein m is at least 1 and is preferably 3 or 4, a is at least 1 and preferably is 1, p is a number which provides a moiety weight of 400 to 10,000 and is preferably at least 30, R₁₀ is a diradical of a diisocyanate after removal of the isocyanate group, such as the diradical of isophorone diisocyanate, and each E″ is a group represented by:

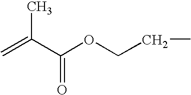

A preferred silicone hydrogel material comprises (based on the initial monomer mixture that is copolymerized to form the hydrogel copolymeric material) 5 to 50 percent, preferably 10 to 25, by weight of one or more silicone macromonomers, 5 to 75 percent, preferably 30 to 60 percent, by weight of one or more polysiloxanylalkyl (meth)acrylic monomers, and 10 to 50 percent, preferably 20 to 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 to Deichert et al. discloses additional unsaturated groups, including acryloxy or methacryloxy. Fumarate-containing materials such as those taught in U.S. Pat. Nos. 5,512,205; 5,449,729; and 5,310,779 to Lai are also useful substrates in accordance with the invention. Preferably, the silane macromonomer is a silicon-containing vinyl carbonate or vinyl carbamate or a polyurethane-polysiloxane having one or more hard-soft-hard blocks and end-capped with a hydrophilic monomer.

Specific examples of ophthalmic lens materials useful in the present invention are taught in U.S. Pat. No. 6,891,010 (Kunzler et al.); U.S. Pat. No. 5,908,906 (Kunzler et al.); U.S. Pat. No. 5,714,557 (Kunzler et al.); U.S. Pat. No. 5,710,302 (Künzler et al.); U.S. Pat. No. 5,708,094 (Lai et al.); U.S. Pat. No. 5,616,757 (Bambury et al.); U.S. Pat. No. 5,610,252 (Bambury et al.); U.S. Pat. No. 5,512,205 (Lai); U.S. Pat. No. 5,449,729 (Lai); U.S. Pat. No. 5,387,662 (Kunzler et al.); U.S. Pat. No. 5,310,779 (Lai); and U.S. Pat. No. 5,346,976 (Ellis et al.); the disclosures of which are incorporated herein by reference.

In one embodiment, the hydrogel pre-polymer mixture includes a solvent or diluent. Preferably, an organic diluent is included in the initial pre-polymer mixture. As used herein, the term “organic diluent” encompasses organic compounds that are substantially unreactive with the components in the initial mixture, and are often used to minimize incompatibility of the pre-polymer components in this mixture. Representative organic diluents include: monohydric alcohols, such as C₆-C₁₀ monohydric alcohols; diols such as ethylene glycol; polyols such as glycerin; ethers such as diethylene glycol monoethyl ether; ketones such as methyl ethyl ketone; esters such as methyl heptanoate; and hydrocarbons such as toluene.

Curing

Once the mold unit has been assembled it is subjected to a curing cycle, which polymerizes the pre-polymer inside the mold cavity. Typical ophthalmic lens curing methods involve exposing the pre-polymer mixture to light radiation (such as UV radiation or visible light) and/or thermal energy (e.g. oven curing).

De-Capping

Once curing is complete, one of the mold halves is separated from the ophthalmic lens to reveal the ophthalmic lens formed therein. The mold release process breaks the adhesive bond between the mold sections without damaging the ophthalmic lens, which remains bound to the other mold surface. This process is referred to as decapping. In one embodiment, the decapping occurs when a super-cooled fluid is contacted for a period of time to release the anterior mold half from the ophthalmic lens. In another embodiment, the decapping occurs when a super-cooled fluid is contacted for a period of time to release the anterior mold half from the ophthalmic lens.

In one embodiment, the period of time is a minimum of about 0.1 seconds to a maximum of about 20 seconds. Typically, the period of time effective to clean the molding tool is a minimum of about 0.1 seconds, about 0.5 seconds, about 1.0 seconds, about 2.0 seconds or about 5.0 seconds. Typically, the period of time effective to clean the molding tool is a maximum of about 20 seconds, about 15 seconds, about 10 seconds, about 5 seconds, about 3 seconds, about 2 seconds, or about 1 second.

In another embodiment, the contacting occurs by applying an amount of cryogenic fluid to the one half of the ophthalmic lens mold. Optionally, the contacting occurs by spraying the super-cooled fluid over the ophthalmic lens.

In another embodiment, the dose amount of cryogenic fluid contacted with the mold is a maximum of about 1000 μl, about 800 μl, about 600 μl, about 400 μl, about 200 μl, about 100 μl, about 60 μl, about 40 μ, about 20 μl, about 10 μl, about 8 μl, about 5 μl or about 2 μl. In another embodiment, the dose amount of cryogenic fluid contacted with the mold is a minimum of about 10 μl, about 8 μl, about 5 μl, about 2 μl or about 1 μl. To accomplish low dosing, a nitrogen delivery system such as the SEMIFLEX® system from Vacuum Barrier Corporation, Woburn, Mass. (www.vacuumbarrier.com) is advantageous.

In still another embodiment, the super-cooled fluid is at a temperature below about minus 40° C. Typically, the temperature is below about minus 50° C., about minus 60° C. or about minus 70° C. Typically, the super-cooled fluid is a cryogenic fluid.

In another embodiment, the process is selected from the group consisting essentially of nitrogen, argon, helium, air and carbon dioxide. Preferably, the super-cooled fluid is an inert atmospheric gas. More preferably, the super-cooled fluid is nitrogen.

Solvent Removal

An optional step following de-capping is solvent removal. Unreacted solvent can be removed from the molded ophthalmic lens to further stiffen the ophthalmic lens. Preferably, solvents are volatile thus exposure to air at room temperature for a period of time will remove solvent. Nonetheless, a solvent can be removed in less time by placing the ophthalmic lens in an oven. After the solvent is evaporated from the ophthalmic lens, the ophthalmic lens is removed from the oven for additional processing. The step of solvent removal is preferably performed after the de-capping step and before reservoir removal. Optionally, the step of solvent removal can occur after reservoir removal, but before lens extraction. In another embodiment, the step of solvent removal is avoided by the process of the present invention before the step of releasing the ophthalmic lens. Solvent is optionally extracted or removed from the ophthalmic lens during the step of lens release or during a later step of monomer extraction/lens cleaning where the ophthalmic lens is optionally immersed in or sprayed with a super-cooled fluid.

Reservoir Removal

The manufacturing line may comprise a reservoir removal station to ensure the ophthalmic lens flash or reservoir is removed from the anterior mold section. Optionally, reservoir removal occurs by cutting the reservoir from the ophthalmic lens with a knife blade, which strips the annular lens flash or reservoir from the top of the mold section. Thus, immediately following mold release from the other lens half or second lens half, the reservoir remains bonded to the mold surface and the ophthalmic lens releases from the mold and the reservoir.

Alternatively, the use of a cryogenic fluid can be used to remove the reservoir from the ophthalmic lens during the de capping or lens release step. A temperature differential occurs between the ophthalmic lens flash and/or the mold on the one hand and the ophthalmic lens on the other hand. For example, a cryogenic fluid carefully applied and dosed to ophthalmic lens directly after decapping will create a temperature differential between the ophthalmic lens between the ophthalmic lens and both the mold and the ophthalmic lens flash. The temperature differential will typically separate the ophthalmic lens from both the ophthalmic lens flash and the other mold half or the second mold half.

Lens Release

Next, the ophthalmic lens is released from the other mold or second mold half to which it is attached after the step of decapping. The ophthalmic lens is released when a super-cooled fluid (preferably a cryogenic fluid) is contacted with the ophthalmic lens or the second mold half to release the ophthalmic lens from the second mold half. The super-cooled fluid creates a sudden temperature differential between the ophthalmic lens and the second mold half that will break the bonding between the ophthalmic lens and the second mold half. In one embodiment, the step of pre-polymer extraction, solvent extraction and/or lens cleaning occurs during the step of lens release. In another embodiment, the step of pre-polymer extraction, solvent extraction and/or lens cleaning occurs after the step of lens release.

In one embodiment, the ophthalmic lens release occurs when a super-cooled fluid is contacted for a period of time with either the ophthalmic lens or the anterior mold half to release the anterior mold half ftom the ophthalmic lens. In another embodiment, the ophthalmic lens release occurs when a super-cooled fluid is contacted with the ophthalmic lens or posterior mold half for a period of time to release the posterior mold half from the ophthalmic lens.

In one embodiment, the period of time is a minimum of about 0.1 seconds to a maximum of about 20 seconds. Typically, the period of time is a minimum of about 0.1 seconds, about 0.5 seconds, about 1.0 seconds, about 2.0 seconds or about 5.0 seconds. Typically, the period of time is a maximum of about 20 seconds, about 15 seconds, about 10 seconds, about 5 seconds, about 3 seconds, about 2 seconds or about 1 second.

In another embodiment, the contacting occurs by applying an amount of cryogenic fluid to the one half of the ophthalmic lens mold. Optionally, the contacting occurs by spraying the super-cooled fluid over the ophthalmic lens.

In another embodiment, the dose amount of cryogenic fluid contacted with the mold is a maximum of about 1000 μl about 800 μl, about 750 μl, about 600 μl, about 500 μl, about 400 μl, about 200 μl, about 100 μl, about 60 μl, about 40 μul, about 20 μl, about 10 μl, about 8 μl, about 5 μl or about 2 μl. In another embodiment, the dose amount of cryogenic fluid contacted with the mold is a minimum of about 10 μl, about 8 μl, about 5 μl, about 2 μl or about 1 μl. To accomplish low dosing, a nitrogen delivery system such as the SEMIFLEX® system from Vacuum Barrier Corporation, Woburn, Mass. (www.vacuumbarrier.com) is advantageous.

In still another embodiment, the super-cooled fluid is at a temperature below about minus 40° C. Typically, the temperature is below about minus 50° C., about minus 60° C., about minus 70° C. Typically, the super-cooled fluid is a cryogenic fluid.

In another embodiment, the process is selected from the group consisting essentially of nitrogen, argon, helium, air and carbon dioxide. Preferably, the super-cooled fluid is an inert atmospheric gas. More preferably, the super-cooled fluid is nitrogen.

In one embodiment of the present invention, the step of releasing the ophthalmic lens by contacting the ophthalmic lens with a super-cooled fluid, preferably a cryogenic fluid for a period of time sufficient to release the ophthalmic lens is followed by additional dry processing steps. By dry processing steps it is meant processing steps that improve the quality and condition of the ophthalmic lens prior to hydration of the ophthalmic lens. Additional processing steps may include edging/polishing of the ophthalmic lens, solvent removal, monomer extraction (with a solvent other than an aqueous solvent), lens cleaning, inspection, lens coating or other surface treatments, etc.

In another embodiment of the present invention, the step of releasing the ophthalmic lens by contacting the ophthalmic lens with a super-cooled fluid, preferably a cryogenic fluid for a period of time sufficient to release the ophthalmic lens is followed by additional dry processing steps. By dry processing steps it is meant processing steps that improve the quality and condition of the ophthalmic lens prior to hydration of the ophthalmic lens.

Edging/Polishing

In still another embodiment, the ophthalmic lens edge is optionally smoothed and polished. The smoothing of the ophthalmic lens removes lens fragments or portions of the ophthalmic lens reservoir that might adhere to the ophthalmic lens following reservoir removal and/or lens release. The polishing of the ophthalmic lens is generally known in the art and results in an ophthalmic lens that has improved edge surface for comfort. However, after edging and polishing, the ophthalmic lens will have debris in contact with the ophthalmic lens and will require cleaning.

Lens Cleaning/Pre-polymer Extraction

A cryogenic fluid is used in one embodiment of the present invention to clean the ophthalmic lens of debris and extract pre-polymer and/or solvent. Pre-polymer and or solvent is extracted from a polymer lens by contacting the ophthalmic lens with a super-cooled solvent for a period of time sufficient to extract pre-polymer from the polymer lens.

In one embodiment, the period of time is a minimum of about 0.1 seconds to a maximum of about 20 seconds. Typically, the period of time effective to clean the ophthalmic lens is a minimum of about 0.1 seconds, about 0.5 seconds, about 1.0 seconds, about 2.0 seconds or about 5.0 seconds. Typically, the period of time effective to clean the ophthalmic lens is a maximum of about 20 seconds, about 15 seconds, about 10 seconds, about 5 seconds, about 3 seconds, about 2 seconds or about 1 second.

In another embodiment, the contacting occurs by immersing the ophthalmic lens in a bath containing the super-cooled fluid. Optionally, the contacting occurs by spraying the super-cooled fluid over the ophthalmic lens.

In still another embodiment, the super-cooled fluid is at a temperature below minus 40° C. Typically, the temperature is below about minus 50° C., about minus 60° C. and about minus 70° C. Typically, the super-cooled fluid is a cryogenic fluid.

In another embodiment, the process is selected from the group consisting essentially of nitrogen, argon, helium, air and carbon dioxide. Preferably, the super-cooled fluid is an inert atmospheric gas. More preferably, the super-cooled fluid is nitrogen.

Typically, the extraction of pre-polymers occurs after the ophthalmic lens is removed from a mold that forms the ophthalmic lens. Optionally, the extraction of pre-polymers occurs while the ophthalmic lens is being released from a mold that forms the ophthalmic lens.

Washing and Hydration

After the inspection stage, the ophthalmic lenses proceed to a washing and/or hydration stage depending upon the type of lens. Typically, the ophthalmic lenses are supported on a carrier that supports a plurality of lenses in separate compartments e.g. 16, 32 etc. Optionally, the final packaging is used as the carrier during the washing and hydration step. In either instance, each lens is washed with purified water or in the case of hydrogel lenses hydrated with purified water until it has expanded to its full dimensions. Alternatively, the ophthalmic lens is washed or hydrated with a buffered saline solution in one or more washing steps. Water (or buffered saline solution) is extracted from the polymer matrix of the ophthalmic lens. Fresh water added to rinse the ophthalmic lenses. The ophthalmic lenses may be subjected to several rinses by extraction and addition of purified water. Preferably, a check is made to ensure the presence of an ophthalmic lens in a compartment after each extraction of water. It is believed that the previous step of pre-polymer extraction with a super-cooled fluid will reduce the number of stages of rinses with water or buffered saline solution.

Inspection

Optionally, the ophthalmic lenses are inspected to identify lenses with optical defects. The inspection can be manual or automatic. If an ophthalmic lens fails the inspection test, it is deposited in a reject bin. If the ophthalmic lens passes the inspection test, the ophthalmic lens can be conveyed to the next processing step. The inspection step occurs prior to packaging. Typically, inspection occurs immediately prior to packaging. Alternatively or additionally, the inspection step occurs before the contact lens is hydrated. In one embodiment, an inspection step occurs after the ophthalmic lens is released from the mold and before the contact lens is further processed.

Packaging

Transferred from the carrier into containers or blisters for final packaging the identity of the ophthalmic lenses is monitored via the carrier indicator. For example, the carrier identifier may be scanned as the carrier enters a processing station which will trigger the computer to provide the necessary information for printing a label or information directly on the lid stock which is applied to feel the blisters or containers. In general, applying a lid stock which is heat-sealed to the perimeter of the blister or container seals the blisters or containers.

Suitable lid stock comprises a laminate of metal foil on a polypropylene film. The lid stock may be printed e.g. by laser etching before or after its application to the container or blister. Alternatively, a label may be printed and applied to the lid stock before or after its application. The information printed on the lid stock or label may provide information for use by the end user or may be a machine readable identifier e.g. bar code, matrix code etc. to be used in later packaging operations. The labeling will provide sufficient information such that the ophthalmic lens in each blister or container may be identified in terms of its prescription and SKU, if necessary by interrogating the computer database. Thus, product integrity is ensured from inspection of the individual lens to its packaging in the blister or container.

Prior to application of the lid stock each blister or container is checked for the presence of an ophthalmic lens. After application of the lid stock the container or blister is examined for leaks and bad seals.

Thereafter, the packaged lenses are subjected to sterilization. The blisters or containers may be transferred to a tray or carrier for passage through the sterilization stage. The carrier is provided with a carrier indicator which is read and the information recorded in the computer memory so that the identity of the ophthalmic lenses and SKU is associated with the carrier indicator information.

After sterilization the ophthalmic lenses may be stored in a warehouse and cartoned and labeled in response to a specific order. Alternatively, the ophthalmic lenses may be cartoned and labeled to fulfill an order or for stockpiling ready for future orders.

What is claimed is:

1. A process for manufacturing an ophthalmic lens comprising:
forming an ophthalmic lens from pre-polymer in a mold having an anterior half and a posterior half;
contacting one half of the anterior half or the posterior half with a super-cooled fluid to preferentially release the ophthalmic lens from the one half; and creating a temperature differential between the other half of the anterior half or the posterior half with a super-cooled fluid to release the ophthalmic lens from the other half.

2. The process of claim 1, wherein the one half is the posterior half.

3. The process of claim 1, wherein the contacting occurs on the non-critical surface of the mold.

4. The process of claim 1, wherein the step of forming produces a reservoir ring formed from excess pre-polymer, further comprising the step of creating a temperature differential between the reservoir ring and the ophthalmic lens to facilitate separation of the reservoir ring from the ophthalmic lens.

5. The process of claim 1, wherein the mold is made of an amorphous polymers.

6. The process of claim 1, wherein the ophthalmic lens is made from a silicone containing pre-polymer.

7. The process of claim 1, wherein the pre-polymer is a hydrophilic pre-polymer.

8. The process of claim 1, wherein at least one pre-polymer is selected from the group consisting of amide monomers such as N,N-dimethylacrylamide and N,N-dimethylmethacrylamide; cyclic lactam monomers such as N-vinyl-2-pyrrolidone; (meth)acrylated alcohol monomers, such as 2-hydroxyethylmethacrylte and 2-hydroxyethylacrylate; (meth)acrylated poly(alkene glycol) monomers, such as poly(diethylene glycol) monomers of varying chain length containing monomethacrylate or dimethacrylate; hydrophilic vinyl carbonate monomers; hydrophilic vinyl carbamate monomers; and hydrophilic oxazolone monomers.

9. The process of claim 1, wherein the step of contacting occurs for a minimum of about 0.1 seconds to a maximum of about 20 seconds.

10. The process of claim 9, wherein the step of contacting occurs by spraying the super-cooled fluid over the exterior of the one half.

11. The process of claim 9, wherein the step of contacting occurs by dispensing a volume of super-cooled fluid on the exterior of the one half.

12. The process of claim 1, wherein the step of creating a temperature differential occurs by contacting a super-cooled fluid against the other half of the mold.

13. The process of claim 1, wherein the step of creating a temperature differential occurs by contacting a super-cooled fluid against the other half of the mold for a minimum of about 0.1 seconds to a maximum of about 20 seconds.

14. The process of claim 1, wherein the step of creating a temperature differential contacts the super-cooled fluid against the ophthalmic lens.

15. The process of claim 1, wherein the step of creating a temperature differential contacts the super-cooled fluid against the ophthalmic lens for a minimum of about 0.1 seconds to a maximum of about 20 seconds.

16. The process of claim 1, wherein the step of creating a temperature differential comprises spraying the super-cooled fluid over the exterior of the other half.

17. The process of claim 1, wherein the step of creating a temperature differential comprises spraying the super-cooled fluid over the ophthalmic lens.

18. The process of claim 1, wherein the step of creating a temperature differential comprises dispensing a volume of super-cooled fluid on the exterior of the other half.

19. The process of claim 1, wherein the step of creating a temperature differential comprises dispensing a volume of super-cooled fluid on the exterior of the other half.

20. The process of claim 1, wherein the super-cooled fluid is at a temperature below minus 40° C.

21. The process of claim 1, wherein the super-cooled fluid is selected from the group consisting essentially of nitrogen, argon, helium, air and carbon dioxide.

22. A process for removing an ophthalmic lens from a mould, the process comprising the steps of:
providing an ophthalmic lens in a mold comprising a first mold half and a second mold half;
creating a first temperature differential between the first mold half and the ophthalmic lens to separate the first mold half from the ophthalmic lens; and
creating a second temperature differential between the second mold half and the ophthalmic lens to separate the second mold half from the ophthalmic lens.

23. The process of claim 22, wherein the ophthalmic lens has a reservoir ring formed from excess pre-polymer, further comprising the step of creating a temperature differential between the reservoir ring and the ophthalmic lens to facilitate separation of the reservoir ring from the ophthalmic lens.

24. The process of claim 22, wherein the mold is made of an amorphous polymers.

25. The process of claim 22, wherein the ophthalmic lens is made from a silicone containing pre-polymer.

26. The process of claim 22, wherein the pre-polymer is a hydrophilic pre-polymer.

27. The process of claim 22, wherein at least one pre-polymer is selected from the group consisting of amide monomers such as N,N-dimethylacrylamide and N,N-dimethylmethacrylamide; cyclic lactam monomers such as N-vinyl-2-pyrrolidone; (meth)acrylated alcohol monomers, such as 2-hydroxyethylmethacrylte and 2-hydroxyethylacrylate; (meth)acrylated poly(alkene glycol) monomers, such as poly(diethylene glycol) monomers of varying chain length containing monomethacrylate or dimethacrylate; hydrophilic vinyl carbonate monomers; hydrophilic vinyl carbamate monomers; and hydrophilic oxazolone monomers.

28. The process of claim 22, wherein the step of creating a first temperature differential occurs for a minimum of about 0.1 seconds to a maximum of about 20 seconds.

29. The process of claim 28, wherein the step of creating a first temperature differential occurs by spraying the super-cooled fluid over the exterior of the first half.

30. The process of claim 28, wherein the step of creating a first temperature differential occurs by dispensing a volume of super-cooled fluid on the exterior of the first half.

31. The process of claim 22, wherein the step of creating a second temperature differential occurs by contacting a super-cooled fluid against the second half of the mold.

32. The process of claim 22, wherein the step of creating a second temperature differential occurs by contacting a super-cooled fluid against the second half of the mold for a minimum of about 0.1 seconds to a maximum of about 20 seconds.

33. The process of claim 22, wherein the step of creating a second temperature differential contacts the super-cooled fluid against the ophthalmic lens.

34. The process of claim 22, wherein the step of creating a second temperature differential contacts the super-cooled fluid against the ophthalmic lens for a minimum of about 0.1 seconds to a maximum of about 20 seconds.

35. The process of claim 22, wherein the step of creating a second temperature differential comprises spraying the super-cooled fluid over the exterior of the second half.

36. The process of claim 22, wherein the step of creating a temperature differential comprises spraying the super-cooled fluid over the ophthalmic lens.

37. The process of claim 22, wherein the step of creating a temperature differential comprises dispensing a volume of super-cooled fluid on the exterior of the second half.

38. The process of claim 22, wherein the step of creating a temperature differential comprises dispensing a volume of super-cooled fluid on the exterior of the second half.

39. The process of claim 22, wherein the super-cooled fluid is at a temperature below minus 40° C.

40. The process of claim 22, wherein the super-cooled fluid is selected from the group consisting essentially of nitrogen, argon, helium, air and carbon dioxide.
